(19) United States
(12) Patent Application Publication
(10) Pub. No.: US 2008/0115102 A1
(43) Pub. Date: May 15, 2008

(54) System and method for automatic elimination of connectivity mismatches during construction of a mask layout block, maintaining process design rule correctness

(76) Inventor: Dan Rittman, Atlit (IL)

Correspondence Address: DANNY RITTMAN, P.O. Box 2040, Atlit, 30300, omitted

(21) Appl. No.: 11/598,422

(22) Filed: Nov. 14, 2006

(51) Int. Cl. G06F 17/50

(52) U.S. Cl. 716/19

(57) ABSTRACT

A system and method for automatic elimination of connectivity mismatches during construction of a mask layout block, maintaining the process design rules (DRC Clean) and layout connectivity (LVS Clean) correctness are disclosed. The method includes analyzing a selected polygon or net for connectivity, in a mask layout block and comparing it to a netlist that is associated with the polygon or net. The method includes comparing a physical connection in a mask layout database within a commercial layout editor to a corresponding connection in a schematic netlist and/or external constraints file. A connectivity mismatch is identified if the physical connection in the commercial layout editor database does not match the same connection in the netlist and/or external constraints file. When a mismatch is identified the connectivity error is graphically presented in the mask layout database within commercial layout editor. The method and system also provides an option to automatically correct the connectivity mismatch during the construction of the mask layout block within commercial layout editor using the editor's commands and functions.

### BACKGROUND OF INVENTION

1. Technical Field of the Invention

The present invention is generally related to the field of integrated circuits, and more particularly to a system and method for eliminating connectivity mismatches during construction of a mask layout block in a commercial layout editor environment using the editor's commands and functions, maintaining the process design rules (DRC Clean) and layout connectivity (LVS Clean) correctness.

2. Background of the Invention

Nanometer designs contain millions of devices and operate at very high frequencies. To meet the challenges posed by such large-scale circuits, techniques have been developed to represent integrated circuit designs at various levels of abstraction. According to these techniques, an integrated circuit design may be represented by an electrical schematic containing devices and nets interconnecting the devices and by geometric layout data that describes patterns of regions or elements to be formed in and/or on an integrated circuit substrate. (e.g., wafer)

Techniques for managing highly integrated circuit designs include hierarchical design techniques. Using such techniques, a particular design is partitioned into functional cells and cells-within-cells, etc., so that at a given level of hierarchy the design may be analyzed as a set of cells and their respective interconnections, without being concerned with all the details of the contents of the cells (e.g., subcells within each cell). These hierarchical techniques can be essential to the efficient performance of computer-assisted integrated circuit design verification. Such verification may include operations to perform layout versus schematic comparison (LVS) using computer-based design tools. As will be understood by those skilled in the art, tools to perform layout versus schematic comparison may include extraction software to extract a layout netlist from geometric layout data. An extracted layout netlist is then compared to an electrical schematic netlist to determine functional equivalence between the original integrated circuit schematic and the integrated circuit layout. One difficulty associated with the performance of these operations may be caused by dissimilarity in the labeling of nets and devices in the extracted layout netlist relative to the electrical schematic netlist.

A typical semiconductor design process includes numerous steps. Initially, a schematic diagram that represents an integrated circuit is prepared. The schematic diagram provides a representation of the logical connections between logic elements that form the integrated circuit. Once the schematic diagram has been tested to verify that the circuit performs the correct functions, the schematic diagram is converted into a mask layout database that includes a series of polygons. The polygons may represent the logic elements and the logical connections from the schematic diagram. The mask layout database is then used to form a series of photomasks, also know as masks or reticles, that may be used to manufacture the different layers of the integrated circuit.

Typically, the mask layout database is created manually by a mask designer or automatically by a synthesis tool. Once the mask layout database is complete; polygons that form electrical connections in the mask layout database are compared to the logical connections from the schematic diagram. This comparison may result in connection mismatches between the schematic diagram and the mask layout database. A connection mismatch typically indicates that an electrical connection in the mask layout database does not match its corresponding logical connection in the schematic diagram.

Today, any mismatches are corrected manually by a layout designer. The layout designer first must find the correct connection and then determine how to create the correct electrical connection in the mask layout database. Typically, the layout designer is required to delete the mismatched connection in the mask layout database and locate a path through existing polygons in the mask layout database. Once an appropriate path through the mask layout database is found, the layout designer creates a new electrical connection in the mask layout database that matches the corresponding logical connection in the schematic diagram. This process of adding the new electrical connection may take several hours or days to complete. Furthermore, the layout designer may introduce design rule errors in the mask layout database when adding the new connection. Eliminating the design rule errors may additionally require several more hours or days and thus, increase the design time for the integrated circuit. Using this invention these electrical connection mismatches are eliminated a head of time during the construction of the mask layout blocks and therefore a significant time saving is done which resulting massive reduction in the entire chip design cycle.

### SUMMARY OF THE INVENTION

In accordance with the present invention, the disadvantages and problems associated with correcting connectivity mismatches in a mask layout file have been eliminated during the construction of the mask layout block, maintaining the process design rules (DRC Clean) and layout connectivity (LVS Clean) correctness, using commercial layout editor commands and functions. In a particular embodiment, an automated method for eliminating connectivity mismatches during the construction of a mask layout database includes identifying a connectivity mismatch in the mask layout database and correcting the connectivity mismatch in the mask layout file under commercial layout editor environment, using the editor's commands and functions, maintaining the process design rules (DRC Clean) and layout connectivity (LVS Clean) correctness.

In accordance with another embodiment of the present invention, the disadvantages and problems associated with eliminating connectivity mismatches during construction of a mask layout block have been substantially reduced or eliminated. In a particular embodiment, a method for eliminating connectivity mismatches during construction of a mask layout block includes automatically preventing a polygon or nets from being placed, created or edited in a selected position in a mask layout block if a connectivity mismatch is identified.

In accordance with one embodiment of the present invention, an automated method for connectivity mismatches during construction of a mask layout block includes analyzing a selected polygon(s) or net(s) in a mask layout block and obtaining one or more connectivity information associated with the polygon from a netlist and/or external constraints file.

The method provides a violation marker associated with the selected position for the polygon or net that graphically represents connectivity mismatch in the mask layout block where the selected polygon's position complies with the connectivity information.

In accordance with one embodiment of the present invention, an automated method for eliminating connectivity mismatches in a mask layout file includes comparing a first connection in the mask layout database, under commercial layout editor to a second connection in a schematic netlist. A connectivity mismatch is identified if the first connection does not match the second connection and the connectivity is automatically eliminated in the mask layout database under commercial editor environment using the editor's commands and functions.

In accordance with another embodiment of the present invention, a computer system for eliminating connectivity mismatches during the construction of a mask layout database under commercial layout editor environment includes a processing resource coupled to a computer readable memory. Processing instructions are encoded in the computer readable memory. The instructions are executed by the processing resource to compare a first connection in a mask layout database under a commercial layout editor to a second connection in a schematic netlist. The instructions further identify a connectivity mismatch in the mask layout database under commercial layout editor if the first connection does not match the second connection and automatically correct the connectivity mismatch in the mask layout database under commercial layout editor environment, maintaining the process design rules (DRC Clean) and layout connectivity (LVS Clean) correctness.

Important technical advantages of certain embodiments of the present invention include a connectivity aware layout versus schematic (CALVS) tool that reduces the design time for an integrated circuit. The CALVS tool checks a mask layout database under commercial layout editor environment for connectivity mismatches identifies and represent any mismatches via graphical representation called Advice Marker. In addition the tool is equipped with the option to show a fly-in that is connected between all correct layout nodes according to netlist and/or external constraints file. If connectivity mismatches are identified, the CALVS tool automatically removes any mismatched connections and replaces the mismatched connections with electrical connections that match the corresponding logical connections in a schematic diagram or external constraints file. By eliminating connectivity mismatches during the construction of a mask layout block under commercial layout editor environment, the time needed for the final sign-off verification process for the mask layout database is substantially reduced.

Another important technical advantage of certain embodiments of the present invention includes a CALVS tool that adds electrical connections to a mask layout database under commercial layout editor environment without introducing design rule errors. The CALVS tool finds paths in the mask layout database under commercial layout editor environment to add an electrical connection that matches the corresponding logical connection from a schematic diagram or external constraints file. When routing the electrical connection, the CALVS tool uses design rules from the commercial layout editor's technology file for a specific manufacturing process and routes the electrical connection to avoid creating any design rule violations.

In accordance with a further embodiment of the present invention, a computer system for eliminating connectivity mismatches during construction of a mask layout block under commercial layout editor environment includes a processing resource coupled to a computer readable memory. Processing instructions are encoded in the computer readable memory. When the processing instructions are executed by the processing resource, the instructions analyze a selected polygon or net in a mask layout block within commercial layout editor and identify an connectivity mismatch in the mask layout block if the electrical connection does not correlates to corresponding netlist or external constraints file. If the connectivity mismatch is identified, the instructions prevent the polygon or nets from being placed, created or edited at the selected position in the mask layout block within commercial layout editor environment.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a block diagram of a computer system for correcting connectivity mismatches during a construction of a mask layout database under commercial layout editor in accordance with the teachings of the present invention;

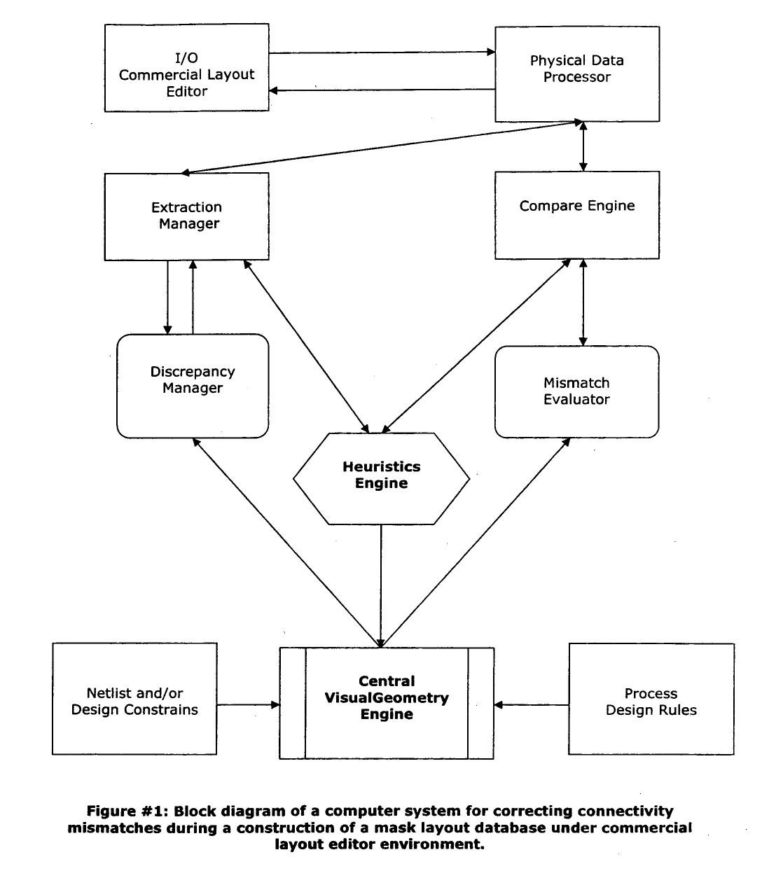

FIG. 2 illustrates a schematic diagram of an example integrated circuit in accordance with the teachings of the present invention; This schematics diagrammatically presents two (2) inverters connected in serial.

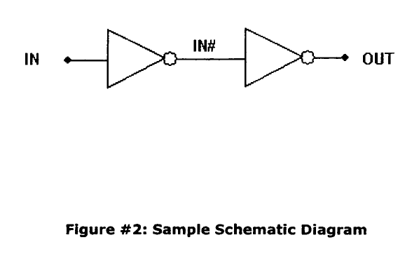

FIG. 3 illustrates a layout view of the example integrated circuit in the schematic diagram of FIG. 2. The physical layout connection is done with connectivity mismatch. The output of Inverter #1 is suppose to be connected to the input of Inverter #2 but mistakenly connected to the output of Inverter #2. (The signal IN# is shorted with the signal OUT)

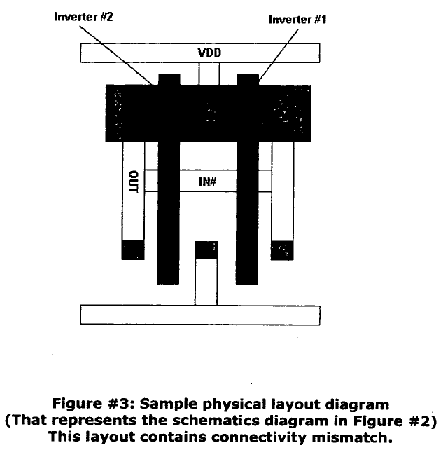

FIG. 4 illustrates a layout view of the example integrated circuit after the connectivity mismatch analysis and the connectivity mismatches graphical representation Advise Marker in accordance with the teachings of the present invention; (The LVS mismatch is represents via the purple arrows)

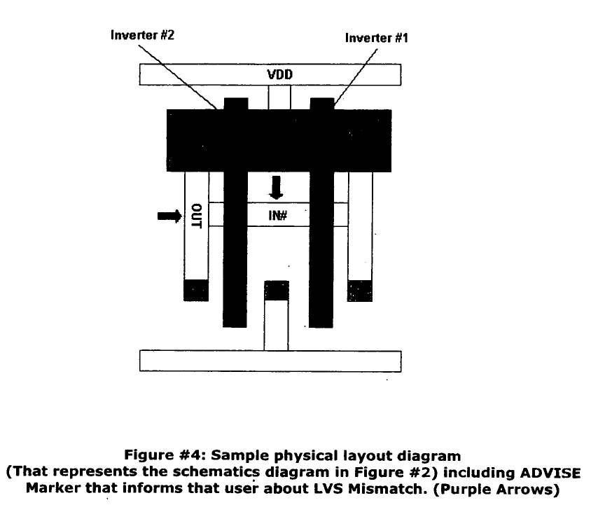

FIG. 5 illustrates the user's option to automatically correct the integrated circuit mask layout database under commercial layout editor's environment by clicking on the: FIX button, located within the Information Window. The Information Window shows all current mismatches connections and required connections.

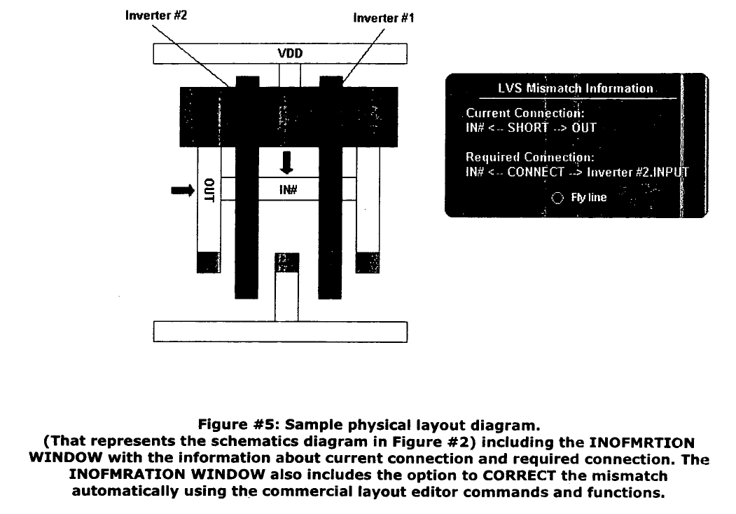

Upon clicking on the FIX button in the Information Window, the system will correct the connectivity mismatches according to the corresponding netlist and/or external constraints file, maintaining design rules dimensions according to commercial layout editor's technology file.

FIG. 6 illustrates the option of generating a Fly-line. The Fly-line shows the correct nodes to be connected.

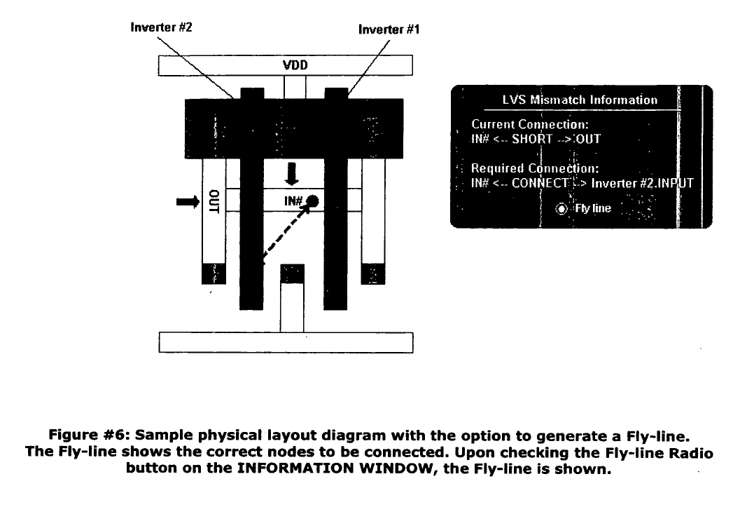

FIG. 7 illustrates the sample layout AFTER the CORRECTION action. The signal IN# which is the OUTPUT of Inverter #1 is connected to the INPUT of Inverter #2.

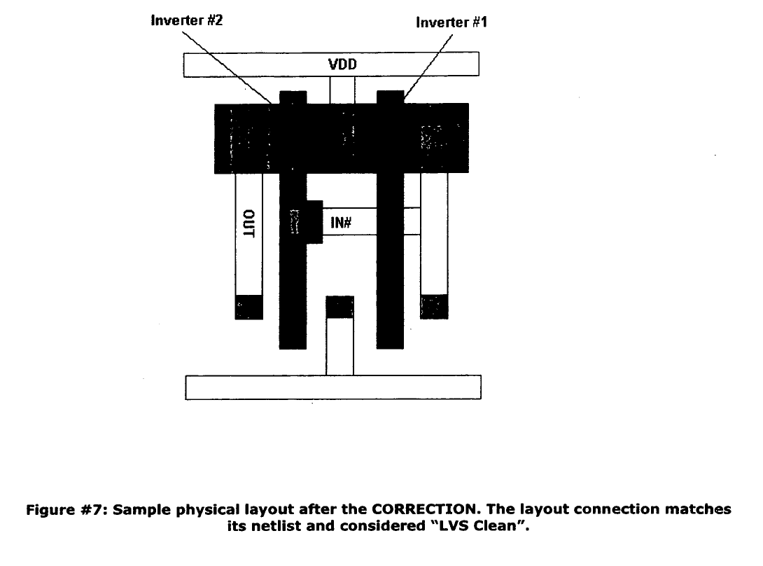

FIG. 8 illustrates the tool's basic interface with layout editor. The system offers Advise mode and Correct mode.

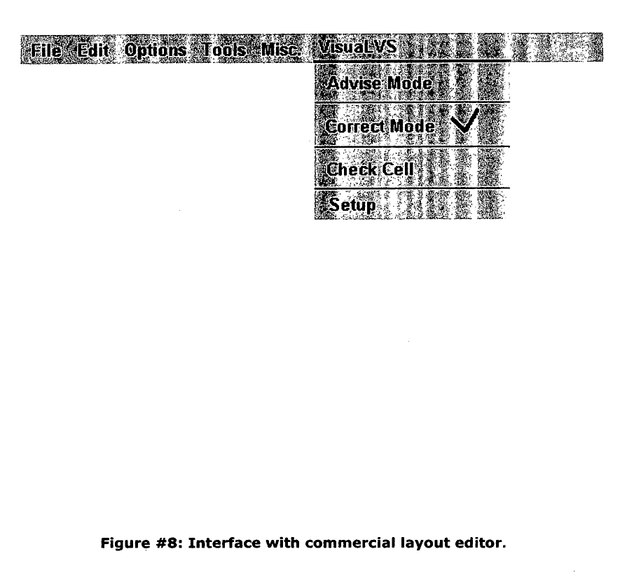

Advise Mode—User receives graphical feedback called Advise Marker during IC layout construction. No automatic correction is performed.

Correct Mode—User actions are automatically corrected by the system to eliminate connectivity mismatches, maintaining the process design rule correctness.

User may check both options to activate the two modes at the same time. If none of these modes are checked, the system is disconnected from the layout editor.

FIG. 9 illustrates a flow chart for one example of a method for eliminating connectivity mismatches during construction of a mask layout block with commercial layout editor's environment in accordance with teachings of the present invention.

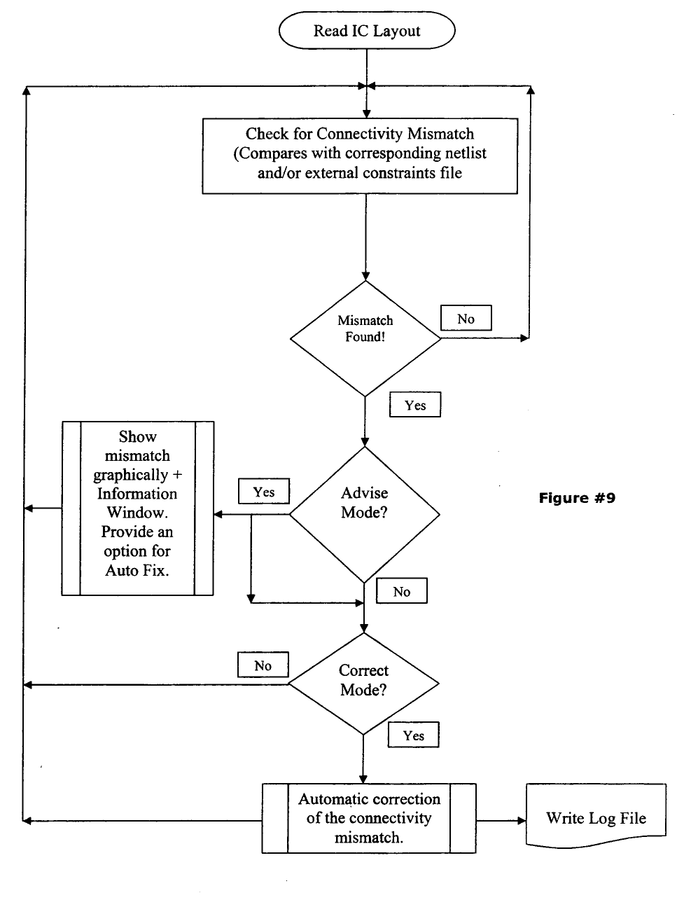

### DETAILED DESCRIPTION OF THE INVENTION

The processing instructions may include a commercially available layout editor interfaced with a Connectivity Aware Layout versus Schematics (CALVS) tool. The CALVS tool may provide the ability to analyze integrated circuit mask layout database within commercial layout editor environment, for electrical connectivity and determine if a connectivity mismatch is created. The CALVS tool may be operated in two different modes: an Advise mode and a Correct mode. When operating in the Advise mode, the CALVS tool may graphically display an Advise marker which shows the required connectivity of the selected polygon or net according to a corresponding netlist and/or external constraints file. In addition the CALVS tool has the capability to show a fly-line which connects the correct layout nodes. In the Correct mode, the CALVS tool may prevent or adjust the creation, placement or edition of polygons or nets in order to eliminate or correct connectivity mismatches, maintaining the process design rules (DRC Clean) and layout connectivity (LVS Clean) correctness.

When a layout designer creates a mask layout block, the CALVS tool reads a corresponding netlist and/or external constraints file. In addition the CALVS tool reads the process technology file from the commercial layout editor environment. The technology file may contain design rules for the desired manufacturing process that ensures an integrated circuit fabricated on a semiconductor wafer functions correctly. The netlist file includes all connectivity information for the mask layout block.

Furthermore, the tool has an option to read another constraints file which contains layout connectivity additional information. The CALVS tool may compare logical connections contained in a netlist or external constrains file generated from a schematic diagram of an integrated circuit with electrical connections contained in a mask layout database within commercial layout editor, generated from the corresponding layout block for the integrated circuit. If the electrical connections in the mask layout file match the logical connections in the netlist, the CALVS tool may generate a graphical representation object that indicates the mask layout database does not include any connectivity mismatches. However, if at least one electrical connection in the mask layout database within commercial layout editor does not match the corresponding logical connection in the netlist, the CALVS tool may generate graphical representation mark called Advice Marker that contains connectivity mismatches information, identified by the CALVS tool in the mask layout database within commercial layout editor environment. This graphical representation marker is then used to locate the electrical connections in mask layout block under commercial layout editor that do not match the corresponding logical connections in the netlist or external constraints file. The CALVS tool automatically deletes the mismatched connections. The CALVS tool removes all of the polygons associated with the mismatched connection and creates new connection in order to correct the mismatch. The CALVS tool may match the nodes in the mask layout database within commercial layout editor environment to the nodes in the netlist and generate electrical connections that match the logical connections. The CALVS tool then automatically routes the electrical connections between the appropriate nodes. The electrical connections are routed though the mask layout database within the commercial layout editor, using the editor's commands and functions, without creating any design rules violations in the mask layout block. The process is performed on all mismatched connections until all the connectivity mismatches are removed from the mask layout block. The CALVS tool then uses the connectivity information provided by corresponding netlist or external constraints file to prevent the layout designer from creating connectivity mismatches during the construction of the mask layout block.

If the layout designer chooses to operate in Advise mode, the layout designer may select a polygon or net by moving a cursor over the desired polygon/net or selecting it. The CALVS tool uses the connectivity information to graphically display the correct connection through an Advise Marker and/or fly-line, within the mask layout block where the layout designer may move, place, create or edit a polygon or a net. If the layout designers selects, creates, edit or move polygons or nets the CALVS tool may graphically guide for the correct location and connection of the polygon or net in order to comply with the corresponding netlist and/or external constraints file.

The CALVS tool may graphically represent the Advise marker in the mask layout block by highlighting the correct node(s) to be connected with an appropriate color and/or pattern. The Advise marker color and/or pattern can be set in an initial tool setup. In addition the CALVS tool may show an Information Window with the current and required conditions. The Information Window also provides with the option to correct the violation.

If the layout designer chooses to operate in Correct mode, the CALVS tool may prevent the layout designer from creating, placing, editing and connecting a polygon or a net in a position within the mask layout block that will cause a connectivity mismatch. If the layout designer attempts to create a polygon or net in a certain width, length or location that does not comply with the netlist and/or external constraints file requirements and causes a connectivity mismatch, the CALVS tool automatically adjusts the polygon or net to the correct width/length size or changing its location. Another example, if the layout designer is stretching a metal polygon's edge in order to connect between two (2) nodes, the CALVS tool automatically stretches the edge to the required length to connect it to the matched node. In case the nodes are not to be connected according to the netlist file then the CALVS tool will not allow them to be connected. If the mask designer attempts to connect these node, the metal wire will not be connected but return to its original position or location with a system warning about LVS mismatch. Another example, if the layout designer is placing a VIA on a connection area between Metal 3 and Metal 4 polygons in order to mistakenly connect two nodes electrically, the CALVS tool will automatically remove the VIA with an Advise Marker notice about an LVS mismatch.

Both two modes operate in flat mode and hierarchical mode. When layout designer chooses to work in hierarchical mode, the CALVS tool will graphically advise about connectivity mismatches throughout the hierarchy in Advise mode. The CALVS tool will enforce connectivity mismatch elimination throughout the hierarchy in Correct mode.

The CALVS tool is included an entire layout block check and fix mode. This mode is aimed to be activated with the completion of the entire layout block. Using this feature the entire block will be analyzed for connectivity mismatches. When analysis is complete all mismatches will be shown using Advise marker. This mode operates in flat or fully hierarchical mode. In addition this mode also provides Auto-Correct feature. After complete analysis of the layout block the user has the option to perform an Auto-Correct action. Upon the activation of this feature all connectivity mismatches will be fixed by using the commercial layout editor commands and functions, maintaining the process design rules (DRC Clean) and layout connectivity (LVS Clean) correctness. For example, after a completion of an integrated circuit layout block under commercial layout editor environment, the user has the option to run Check and Fix feature. The CALVS tool will complete a complete LVS analysis, identifying all connectivity mismatches. Upon the completion of the LVS analysis the CALVS tool will correct all mismatches using the commercial layout editor commands and functions. The CALVS tool may CUT, MOVE, CREATE, ERASE, STETCH or perform any other commercial layout editor command and function in order to correct all connectivity mismatches, within commercial layout editor environment, maintaining the process design rules (DRC Clean) and layout connectivity (LVS Clean) correctness.

The processing instructions for connectivity mismatches elimination during the construction of integrated circuit layout block database within commercial layout editor environment may be encoded in computer-usable media. Such computer-usable media may include, without limitation, storage media such as floppy disks, hard disks, CD-ROMS, DVDs, read-only memory, and random access memory; as well as communications media such wires, optical fibers, microwaves, radio waves, and other electromagnetic or optical carriers.

1. An automated method for eliminating connectivity mismatches during construction of a mask layout block, maintaining the process design rules (DRC Clean) and layout connectivity (LVS Clean) correctness, using a commercial layout editor, comprising: analyzing a selected polygon or net in the mask layout block within commercial layout editor; obtaining one or more connectivity information associated with the polygon or net from a netlist or external constraints file; providing an information window with the current and required net's connectivity parameters; providing a violation marker associated with the selected position for the polygon or net, the violation marker operable to graphically represent a connectivity mismatch in the mask layout block where the selected polygon or net complies with the netlist and/or external constraints file: and providing a fly-line between correct layout nodes; and automatically preventing a layout designer from creating a connectivity mismatch by placing, moving or editing the selected polygon or net.

2. The method of claim 1, further comprising: analyzing the mask layout block during its construction within commercial layout editor for existence of connectivity mismatch which are determined by a netlist and/or external constraints ASCII file which contains net's connectivity parameters and other integrated circuit relate connectivity factors.

3. The method of claim 1, further comprising: determining if the modified connection creates a process design rule violation; and eliminating the design rule violation by further modifying the modified connection within commercial layout editor.

4. The method of claim 1, further comprising generating a clean mask layout database within commercial layout editor that does not include the connectivity mismatch.

5. The method of claim 1, wherein the selected position for the polygon or net comprises a location for the polygon in the mask layout block.

6. The method of claim 1, further providing an information window with the current and required net's connectivity parameters. This window also provides the option to automatically correct the physical layout within commercial layout editor environment, maintaining the process design rules (DRC Clean) and layout connectivity (LVS Clean) correctness.

7. The method of claim 1, wherein correcting the connectivity mismatch comprises: disconnecting the wrong connection via erasing the entire net connections and; locating the correct layout nodes in the mask layout database within commercial layout editor, that are matched according to a schematic netlist or external constraints file; and creating a new connection between matched layout nodes using commercial layout editor commands and functions, maintaining the process design rules (DRC Clean) and layout connectivity (LVS Clean) correctness.

8. The method of claim 1, further providing a violation marker associated with the selected position for the polygon or net, the violation marker operable to graphically represent a connectivity mismatch in the mask layout block where the selected polygon or net complies with the netlist and/or external constraints file.

9. The method of claim 1, further providing a fly-line marker associated with the selected position for the polygon or net, the fly-line marker operable to graphically represent the correct connectivity between the nodes in the mask layout block where the selected polygon or net complies with the netlist and/or external constraints file.

10. The method of claim 1, wherein the mask layout block and the netlist and/or external constraints file are hierarchical.

11. An automated method for eliminating connectivity mismatches during construction of a mask layout block, maintaining the process design rules (DRC Clean) and layout connectivity (LVS Clean) correctness, within commercial layout editor environment, comprising: analyzing a selected polygon or net in the mask layout block; providing a violation marker associated with the polygon or net and; providing a fly-line between correct layout nodes; determining if the selected connection of the selected polygon or net produces a connectivity mismatch in the mask layout block based on a netlist and/or external constraints file; and automatically preventing a layout designer from creating, placing or editing the polygon or net in the mask layout block at the selected position based on the violation marker if the connectivity mismatch exists.

12. The method of claim 11, further comprising: automatically determining if the modified connection creates a process design rule violation; and automatically eliminating the design rule violation by further modifying the modified connection within commercial layout editor.

13. The method of claim 11, further comprising automatically placing the polygon or net in an original position in the mask layout block if the connectivity mismatch exists.

14. The method of claim 11, further comprising automatically adjusting the selected polygon or net until the connectivity mismatch is eliminated, maintaining the process design rules (DRC Clean) and layout connectivity (LVS Clean) correctness.

15. The method of claim 11, further comprising automatically adjusting the width of the selected polygon until the connectivity mismatch is eliminated, maintaining the process design rules (DRC Clean) and layout connectivity (LVS Clean) correctness.

16. The method of claim 11, further comprising automatically adjusting the length of the selected polygon until the connectivity mismatch is eliminated, maintaining the process design rules (DRC Clean) and layout connectivity (LVS Clean) correctness.

17. The method of claim 11, further comprising automatically adjusting the amount of the contacts or VIAs until the connectivity mismatch is eliminated, maintaining the process design rules (DRC Clean) and layout connectivity (LVS Clean) correctness.

18. The method of claim 11, wherein the mask layout block and netlist and/or external constraints file are hierarchical.

19. The method of claim 11, further comprising: the mask layout block including at least one top-level cell and one or more instances of a subcell located in the top-level cell; and determining if the selected polygon produces a connectivity mismatch in one or more instances of a subcell in the mask layout block, the subcell located in a top-level cell; and simultaneously preventing the layout designer from creating or placing the polygon or net in mask layout block at the selected position based on the violation marker in each instance of the subcell if the connectivity mismatch exists.

20. The method of claim 11, further comprising generating a mask layout file from the mask layout block that does not include the connectivity mismatch.

21. A computer system for eliminating connectivity mismatches during construction of a mask layout block, maintaining the process design rules (DRC Clean) and layout connectivity (LVS Clean) correctness, comprising: a processing resource; a computer readable memory; and processing instructions encoded in the computer readable memory, the processing instructions, when executed by the processing resource, operable to perform operations comprising: analyzing a selected polygon or net in the mask layout block; providing a violation marker associated with the polygon; providing an information window with the current and required integrated circuit connectivity parameters and; providing a fly-line that connects between the correct layout block's nodes and; determining if the selected position of the selected polygon or net produces a connectivity mismatch in the mask layout block based on a netlist and/or external constraints file; and automatically preventing a layout designer from creating, placing or editing the polygon or net in the mask layout block at the selected position based on the violation marker if the connectivity mismatch exists.

22. The system of claim 21, further comprising the instructions operable to perform operations including automatically placing the polygon or net in an original position in the mask layout block if the connectivity mismatch exists.

23. The system of claim 21, further comprising the instructions operable to perform operations including automatically adjusting the selected polygon or net position until the connectivity mismatch is eliminated, maintaining the process design rules (DRC Clean) and layout connectivity (LVS Clean) correctness.

24. The system of claim 21, further comprising the instructions operable to perform operations including automatically adjusting the width and/or length of the selected polygon until the connectivity mismatch is eliminated, maintaining the process design rules (DRC Clean) and layout connectivity (LVS Clean) correctness.

25. The system of claim 21, further comprising the instructions operable to perform operations including automatically adjusting partial part of the polygon's width and/or length until the connectivity mismatch is eliminated, maintaining the process design rules (DRC Clean) and layout connectivity (LVS Clean) correctness.

26. The system of claim 21, further comprising the instructions operable to perform operations including: determining if the selected position for the polygon or net creates an connectivity mismatch in the mask layout block according to netlist and/or external constraints file; and modifying the selected polygon position, width or length until the connectivity matches to the associated netlist and/or complying with external constraints file.

27. Software for eliminating connectivity mismatches during construction of a mask layout block, maintaining the process design rules (DRC Clean) and layout connectivity (LVS Clean) correctness, the software being embodied in computer-readable media and when executed operable to: analyze a selected polygon or net in the mask layout block; providing a violation marker associated with the polygon or net; providing an information window with the current and required integrated circuit connectivity parameters; and providing a fly-line that is connected between all correct layout block's nodes; and determining if the selected position, width or length of the selected polygon or net produces an connectivity mismatch in the mask layout block based on an netlist and/or external constraints file; and automatically prevent a layout designer from creating, placing or editing the polygon or net in the mask layout block at the selected position based on the violation marker if the connectivity mismatch exists.

28. The software of claim 27, further operable to automatically place the polygon or net in an original position in the mask layout block if the connectivity mismatch exists, maintaining the process design rules (DRC Clean) and layout connectivity (LVS Clean) correctness.

29. The software of claim 27, further operable to automatically adjust the selected polygon's position and width and length until the connectivity mismatch is eliminated, maintaining the process design rules (DRC Clean) and layout connectivity (LVS Clean) correctness.

30. The software of claim 27, further operable to automatically adjust the selected polygon's position and partial width and length until the connectivity mismatch is eliminated, maintaining the process design rules (DRC Clean) and layout connectivity (LVS Clean) correctness.

31. The software of claim 27, further operable to automatically adjust selected VIA's position and/or amount until the connectivity mismatch is eliminated, maintaining the process design rules (DRC Clean) and layout connectivity (LVS Clean) correctness.

32. The software of claim 27, further operable to automatically adjust selected CONTACTS position and/or amount until the connectivity mismatch is eliminated, maintaining the process design rules (DRC Clean) and layout connectivity (LVS Clean) correctness.

33. The software of claim 27 further has the feature to work in CORRECT mode. In CORRECT mode all edited, placed or created polygons or nets are automatically made connectivity correct, maintaining the process design rules (DRC Clean) and layout connectivity (LVS Clean) correctness.

34. The software of claim 27 further has the feature to read commercial layout versus schematic run results and automatically correct connectivity mismatches under commercial layout editor environment using the editor's commands and functions, maintaining the process design rules (DRC Clean) and layout connectivity (LVS Clean) correctness.
